(19) United States
(12) Patent Application Publication
(10) Pub. No.: US 2015/0369145 A1
(43) Pub. Date: Dec. 24, 2015

(54) METHOD OF OPERATING CURRENT CONTROLLED DRIVER MODULE

(71) Applicant: Caterpillar Inc., Peoria, IL (US)

(72) Inventors: William E. Hoban, JR., Dunlap, IL (US); Matthew G. Pennell, Dunlap, IL (US); Amber J. Hoffman, Chillicothe, IL (US); Saneeb Umeer, Dunlap, IL (US)

(73) Assignee: Caterpillar Inc., Peoria, IL (US)

(21) Appl. No.: 14/838,367

(22) Filed: Aug. 28, 2015

(51) Int. Cl. F02D 29/02

(52) U.S. Cl. CPC F02D 29/02

(57) ABSTRACT

A method of operation of a current control driver module for an engine system is provided. The method includes selecting a mode of operation of the current control driver module. The method also includes performing any one of a peak current control and an average current control by the current control driver module based on the selected mode of operation of the current control driver module.

### TECHNICAL FIELD

The present disclosure relates to an engine system, and more particularly to a method of operating a current control driver module of the engine system.

### BACKGROUND

Engine applications such as operator fan, coolant fan, run on varying control modes. Different engine applications use different types of current-controlled drivers that perform either peak current control or average current control. Average current control is typically a software based algorithm and peak current control is typically done via hardware due to response time requirements. Thus, in order to implement both peak and average current control functionality two separate sets of hardware configurations need to be associated with the system which is expensive and hard to implement on an engine system.

U.S. Pat. No. 4,964,014, hereinafter referred as the '014 patent, describes a solenoid current control system that includes a microprocessor. The microprocessor periodically generates a desired peak current value and which energizes the solenoid coil. Current through the coil is sensed via a series resistor and the sensed current is compared to the desired peak current by comparator. The comparator generates an interrupt signal when the sensed current reaches the desired peak value. The interrupt signal is applied to the microprocessor which responds by de-energizing the coil. However, the '014 patent does not describe address providing a compact system which can offer dual functionality of peak and average current control.

### SUMMARY OF THE DISCLOSURE

In one aspect of the present disclosure, a method of operation of a current control driver module for an engine system is provided. The method includes selecting a mode of operation of the current control driver module. The method also includes performing any one of a peak current control and an average current control by the current control driver module based on the selected mode of operation of the current control driver module.

Other features and aspects of this disclosure will be apparent from the following description and the accompanying drawings.

### BRIEF DESCRIPTION OF THE DRAWINGS

FIG. 1 is a schematic view of an exemplary engine system, according to one embodiment of the present disclosure;

FIG. 2 is a schematic diagram of an exemplary current control driver module including a microprocessor, a driver control, and a load, according to one embodiment of the present disclosure; and

FIG. 3 is a flowchart of a method for operating the current control driver module, according to the embodiment of the present disclosure.

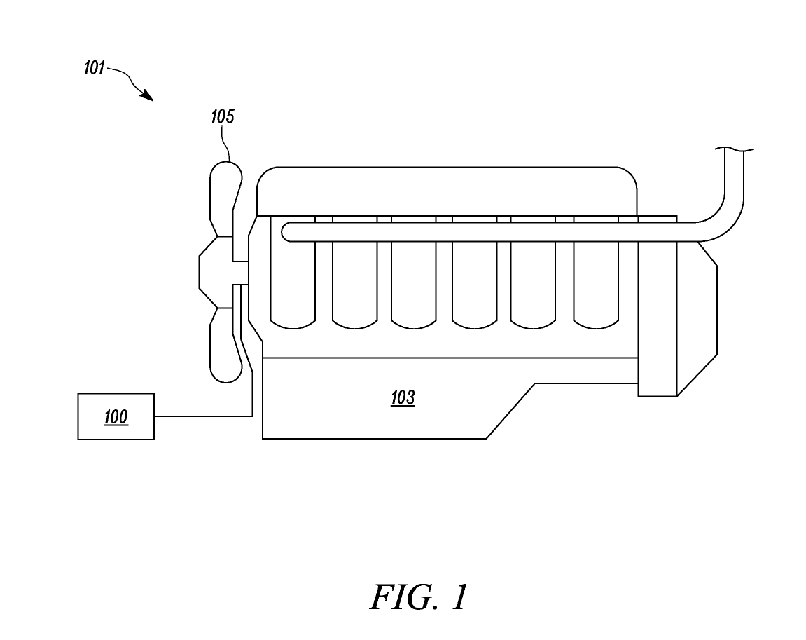

### DETAILED DESCRIPTION

Wherever possible, the same reference numbers will be used throughout the drawings to refer to the same or the like parts. FIG. 1 is a schematic view of an exemplary engine system 101, according to one embodiment of the present disclosure. The engine system 101 includes an engine 103. The engine 103 may embody may one of a compression ignition engine, a spark-ignition engine, or other combustion engines known in the art. In various examples, the engine 103 may have a capacity of 7 liters, 9 liters, and the like based on operational requirements. The engine 103 may be utilized for any suitable application such as motor vehicles, work machines, locomotives or marine engines, and in stationary applications such as electrical power generators. In one example, the engine 103 may include various sensors associated therewith. For example, a temperature sensor (not shown) may be associated with the engine 103. The temperature sensor may generate a signal indicative of a surface temperature of the engine 103.

The engine 103 includes a radiator fan 105. The radiator fan 105 is coupled at a front end of the engine 103. The radiator fan 105 is configured to cool the engine 103 by forcing cooling air over the engine 103. Further, a sensing element (not shown) may be coupled to the radiator fan 105. The sensing element may generate signals indicative of an operational status of the radiator fan 105.

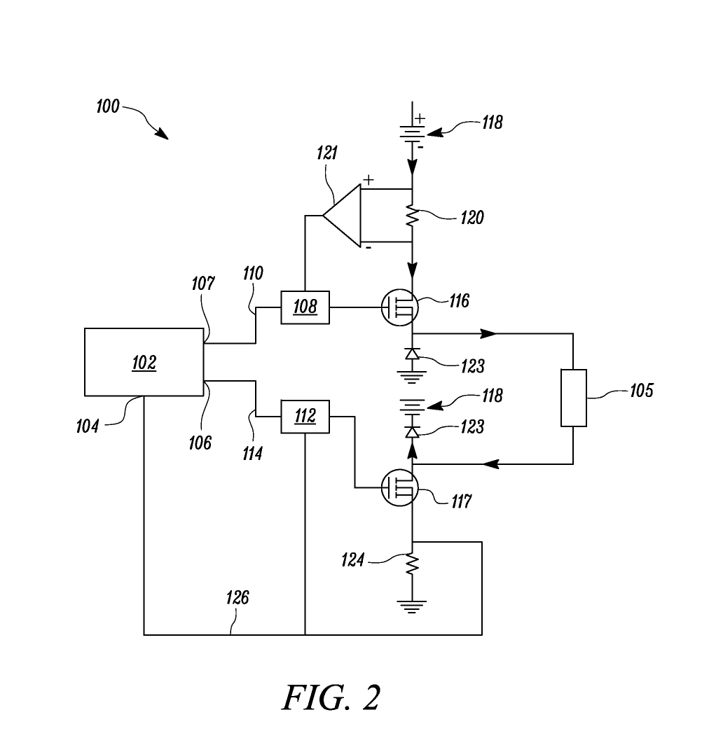

In one example, the radiator fan 105 is communicably coupled to a current control driver module 100. The current control driver module 100 controls current supply to the radiator fan 105. More particularly, the current control driver module 100 is an interface that controls the current supplied to the radiator fan 105. Further, in other examples, the application of the current control driver module 100 may be extended to control the supply of current to a wide number of electrical components, including, but not limited to, various parts of the engine system 101 such as valves, pumps, etc. Details of the current control driver module 100 will now be explained in detail with reference to FIG. 2.

FIG. 2 is a schematic diagram of the exemplary current control driver module 100, according to one embodiment of the present disclosure. The current control driver module 100 is communicably coupled with the temperature sensor associated with the engine 103 and the sensing element associated with the radiator fan 105. Further, the current control driver module 100 receives signals from the temperature sensor and the sensing element. The current control driver module 100 includes a microprocessor 102. The microprocessor 102 includes an analog to digital convertor port 104. The analog to digital convertor port 104 is configured to receive input signals. The input signals are received in analog format that are converted into digital format. The microprocessor 102 also includes a number of pins, for example, a general purpose input output pin 106, hereinafter referred as GPIO pin 106. In the present embodiment, the microprocessor 102 is coupled to a single GPIO pin 106. Alternatively, the microprocessor 102 may include a number of GPIO pins 106. The GPIO pin 106 can be configured either for output signal or input signal. The microprocessor 102 also includes another pin embodied as a microprocessor pin 107. The microprocessor pin 107 is configured to send digital signals.

The current control driver module 100 includes a high side gate driver circuitry 108 and a low side gate driver circuitry 112. The high side gate driver circuitry 108 is in periodic communication with the microprocessor 102 via a line 110. The high side gate driver circuitry 108 is modulated to regulate the current. The high-side gate driver circuitry 108 receives digital signals from the microprocessor pin 107. The low side gate driver circuitry 112 is also communicably coupled to the microprocessor 102 via a control signal line 114. The high-side gate driver circuitry 108 is connected to a high side mosfet 116. The high-side gate driver circuitry 108 is used to convert the digital control signals from the microprocessor 102 to a gate drive voltage in order to control the high side mosfet 116.

The high side mosfet 116 is configured to supply controlled current from a battery 118. The current supplied by the battery 118 passes through a first sensor 120. Further, the current passing through the first sensor 120 is fed back to the high-side gate driver circuitry 108 by means of an OPAMP 121.

The first sensor 120 is configured to convert the current from the battery 118 to a certain voltage that can be sensed by the high side gate driver circuitry 108. The high side mosfet 116 regulates current from the battery 118 to the radiator fan 105. The current from the radiator fan 105 is then grounded by the low side mosfet 117 through the second sensor 124. The current control driver module 100 also includes a flyback diode 123 that is configured to ground the switched terminal of the radiator fan 105.

Further, the low side gate driver circuitry 112 of the current control driver module 100 is used to convert the digital control signals from the microprocessor 102 to control the low side mosfet 117. The current control driver module 100 includes a second sensor 124. In an example, the second sensor 124 is configured to convert the current passing through the radiator fan 105 to voltage that can be sensed by the low side gate driver circuitry 112. Further, the second sensor 124 sends information on current passing through the radiator fan 105 through a feedback line 126.

The working of the microprocessor 102 is controlled by application software that may have algorithm pre-stored into a memory unit (not shown) of the microprocessor 102. The microprocessor 102 is configured to operate in two distinct modes, more particularly; an average current mode and a peak current mode, based on system requirements. The detailed operation of the current control driver module 100 in the peak current mode will now be described in detail with reference to FIGS. 1 and 2.

In one exemplary embodiment, where the engine 103 has a capacity of 9 liters, the radiator fan 105 of the engine 103 may require peak current for operation thereof. During the working of the engine 103, the temperature of the surface of the engine 103 may increase. In such situations, the temperature sensor may send an input signal to the current control driver module 100. The input signal allows an activation of the radiator fan 105, in order to cool the engine 103.

When the current control driver module 100 receives the input signal from the temperature sensor indicating a need of peak current, the microprocessor 102 selects the peak current mode of operation of the current control driver module 100. Alternatively, the selection of the mode of operation of the current control driver module 100 may be provided by any other method not described herein. The application software configures the microprocessor pin 107 as a reaction module output. The reaction module is programmed with current waveform information. The current waveform information may include target current, switching frequency, dither amplitude, and the like. The microprocessor 102 generates a target current control signal in a digital form. The target current control signal is sent to the high-side driver circuitry 108 via the line 110.

The digital signal is converted by the high-side driver circuitry 108 into gate drive voltage that further controls the high side mosfet 116. The high side mosfet 116 supplies the peak current from the battery 118 to the radiator fan 105. The current from the battery 118 is measured by the first sensor 120. Further, the second sensor 124 sends a feedback to the microprocessor 102 through the feedback line 126 to check if the current supplied by the battery 118 confirms the current requirements of the radiator fan 105.

The microprocessor 102 sends a switching frequency control signal on the line 110. The control signal on the control signal line 114 is supplied as digital control signal to the low side gate driver circuitry 112. The digital signal is converted by the low side gate driver circuitry 112 into gate drive voltage that further controls the low side mosfet 117. The current thus supplied is converted into voltage signal that is sensed by the low side gate driver circuitry 112. Further, the signal is fed back to the microprocessor 102.

The reaction module monitors the signal from the second sensor 124 and enables the high-side gate driver circuitry 108 to control the high side mosfet 116 to send current until the target current is reached. The reaction module further turns off the high-side gate driver circuitry 108. The reaction module thus runs independent of any signal from the microprocessor 102. The output current is a peak current controlled waveform. Further, based on the supply of peak current to the radiator fan 105, the current control driver module 100 may receive a feedback signal from the sensing element of the radiator fan 105. The feedback signals may be indicative of the operation of the radiator fan 105.

In another exemplary embodiment, where the engine 103 has a capacity of 7 liter, the radiator fan 105 of the engine 103 may require average current for operation. In such an example, the current control driver module 100 may operate in the average current mode to supply average current to the radiator fan 105. In the average current mode, the application software configures the microprocessor pin 107 as time process unit or TPU output. The signal processing and the flow of current in the average current mode are similar to that described above for the peak current mode. The software algorithm when executed calculates a duty cycle and provides high or low current respectively, based on system requirements. The output current is an average current controlled waveform as the peak current varies based on duty cycle and load time.

The current control driver module 100 is used to read current feedback through the ADC 104, and is read by software as part of a PID control loop for average current control algorithm when selected to be a TPU/software average current control. Additionally, the current feedback is read by the reaction module to indicate a commanded current peak is reached when doing peak current control. The TPU or reaction module output of the current control driver module 100 is selected via software between the TPU and reaction module function, depending on current-control type. The output is used to modulate the high side mosfet 116 to regulate current.

### INDUSTRIAL APPLICABILITY

The present disclosure relates to the current control driver module 100 that may be operated in the average current mode or peak current mode, based on the type of application. The present disclosure allows a single set of hardware to provide peak current control or average current control based on the software configuration of the current control driver module 100. For example, the current control driver module 100 disclosed herein can provide peak current for a particular engine application, based on operational requirements. Further, for a different engine application that requires average current to operate, the current control driver module 100 provides average current using the same circuit arrangement, thereby saving hardware cost.

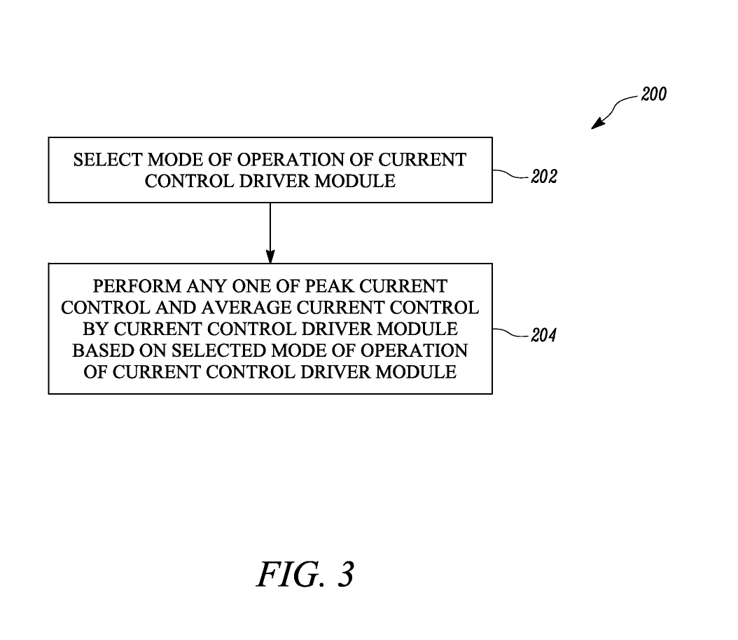

FIG. 3 is a flowchart for a method 200 of operation of the current control driver module 100 for the engine system 101. At step 202, the method 200 selects the mode of operation of the current control driver module 100. At step 204, the method 200 performs the peak current control or the average current control by the current control driver module 100 that is based on the selected mode of operation of the current control driver module 100.

In such situations, although the peak current control may not control the average current as well as average current control; however, the radiator fan 105 information is not required to make the current control functionality of the current control driver module 100 to work. Accordingly, in the present disclosure, the external component or the radiator fan 105 commands a target current, and the current control driver module 100 turns on until the target is reached, and then turns off for the remainder of a switching period.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of operation of a current control driver module for an engine system, the method comprising:
selecting a mode of operation of the current control driver module; and
performing any one of a peak current control and an average current control by the current control driver module based on the selected mode of operation of the current control driver module.
